(19) United States
(12) Patent Application Publication
(10) Pub. No.: US 2015/0016055 A1
(43) Pub. Date: Jan. 15, 2015

(54) PIPING CONNECTION STRUCTURE, COOLING SYSTEM, AND ELECTRONIC EQUIPMENT

(71) Applicant: FUJITSU LIMITED, Kawasaki-shi (JP)

(72) Inventors: Yosuke TSUNODA, Tachikawa (JP); Masumi SUZUKI, Kawasaki (JP); Michimasa AOKI, Kawasaki (JP); Jie WEI, Hachioji (JP)

(73) Assignee: Fujitsu Limited, Kawasaki (JP)

(21) Appl. No.: 14/299,068

(22) Filed: Jun. 9, 2014

(30) Foreign Application Priority Data
Jul. 10, 2013 (JP) 2013-144900

(51) Int. Cl. F16L 21/00; G06F 1/20

(52) U.S. Cl. CPC F16L 21/005; G06F 1/20
USPC 361/679.47; 285/235; 165/181

(57) ABSTRACT

A piping connection structure includes: a pipe; and an elastic tube connected to the pipe, the tube including a connection into which the pipe is inserted and fitted, and a main body linked seamlessly with the connection, wherein the main body includes a projection that is formed circularly along a circumferential direction of the main body, and across the main body in an axial direction, and projects into an inside of the tube in a radial direction with respect to an inner periphery of the connection.

### CROSS-REFERENCE TO RELATED APPLICATION

This application is based upon and claims the benefit of priority of the prior Japanese Patent Application No. 2013-144900, filed on Jul. 10, 2013, the entire contents of which are incorporated herein by reference.

### FIELD

The techniques disclosed herein are related to a piping connection structure, a cooling system, and electronic equipment.

### BACKGROUND

In related art, there is a piping connection structure that has a pipe and a tube into which the pipe is inserted and fitted. In this piping connection structure, a fluid is circulated through the inside of the pipe and tube.

Japanese Laid-open Patent Publication No. 52-151351 and Japanese Laid-open Patent Publication No. 2009-58120 are examples of related art.

In such a piping structure, if the fitting between the pipe and tube has a region in which the cross-sectional area of a flow path changes, fluid pressure loss may occur in this region.

### SUMMARY

According to an aspect of the invention, a piping connection structure includes: a pipe; and an elastic tube connected to the pipe, the tube including a connection into which the pipe is inserted and fitted, and a main body linked seamlessly with the connection, wherein the main body includes a projection that is formed circularly along a circumferential direction of the main body, and across the main body in an axial direction, and projects into an inside of the tube in a radial direction with respect to an inner periphery of the connection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of electronic equipment having a cooling system;

FIG. 2 is a perspective view of a piping connection structure;

FIG. 3 is a vertical cross-sectional view of the piping connection structure;

FIG. 4 is a vertical cross-sectional view of a tube;

FIG. 5 is a vertical cross-sectional view of a variation of the piping connection structure; and

FIG. 6 is a vertical cross-sectional view of a variation of the tube.

### DESCRIPTION OF EMBODIMENT

An embodiment of the techniques disclosed herein is described below.

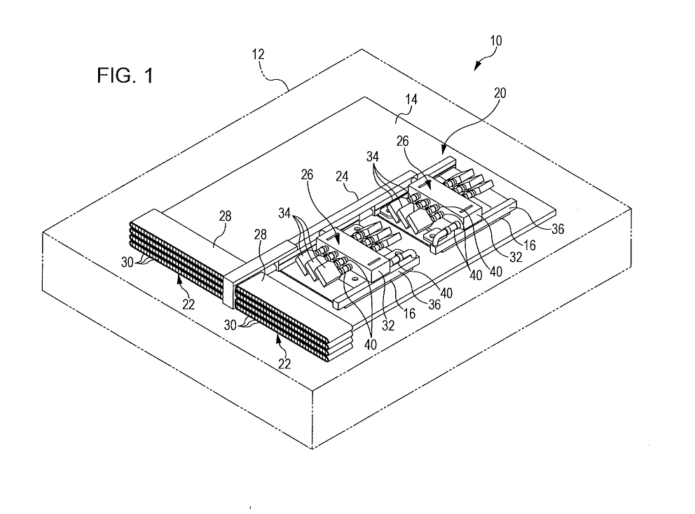

Electronic equipment 10 according to this embodiment illustrated in FIG. 1 is, for example, a server, and has a cabinet 12, a substrate 14, and a cooling system 20. The substrate 14 and the cooling system 20 are housed inside the cabinet 12, which is formed in a flat box shape. The substrate 14 contains a heating element 16 such as a central processing unit (CPU), for example.

The cooling system 20 is used to cool the heating element 16, and has a pair of heat exchangers 22, a connecting pipe 24, and a pair of cooling mechanisms 26. Each heat exchanger 22 has a cooling pipe 28, which is meandering, and a plurality of fins 30, which are disposed inside each U-shaped portion formed in the cooling pipe 28. An outlet of the cooling pipe 28 is connected to an inlet of the connecting pipe 24.

Each cooling mechanism 26 has a tank 32, a plurality of pumps 34, and a heat receiving plate 36. An inlet of the tank 32 is connected to an outlet of the connecting pipe 24. A distribution part and a junction are formed in the tank 32. An inlet of each pump 34 is connected to the distribution part of the tank 32, and an outlet of each pump 34 is connected to the junction of the tank 32. An outlet of the tank 32 is disposed in the junction of the tank 32, and connected to an inlet of the heat receiving plate 36. The heat receiving plate 36 is connected to the heating element 16, and a flow path through which a coolant, which is an example of a fluid, is circulated is formed inside the heat receiving plate 36. In this case, the coolant is cooling water, for example.

In the cooling system 20, when a plurality of the pumps 34 are activated, the coolant discharged from the pumps 34 is supplied to the inside of the heat receiving plate 36 through the junction of the tank 32. When the coolant is supplied to the inside of the heat receiving plate 36, the heating element 16 is cooled by the coolant.

An outlet of the heat receiving plate 36 is connected to an inlet of the heat exchanger 22 via a piping member (not illustrated). The coolant that has been circulated through the inside of the heat receiving plate 36 and has exchanged heat with the heating element 16 is returned to the heat exchanger 22 through the above piping member (not illustrated). The coolant returned to the heat exchanger 22 is cooled by heat exchange with outside air. Then, the coolant cooled in the heat exchanger 22 is returned to the tank 32 through the connecting pipe 24. The coolant is circulated between the heat exchanger 22 and the heat receiving plate 36 in this way, so that the heating element 16 continues to be cooled.

In the above cooling system 20, a piping connection structure 40 according to this embodiment is applied to a connection between the tank 32 and the pump 34, and is also applied to a connection between the tank 32 and the heat receiving plate 36.

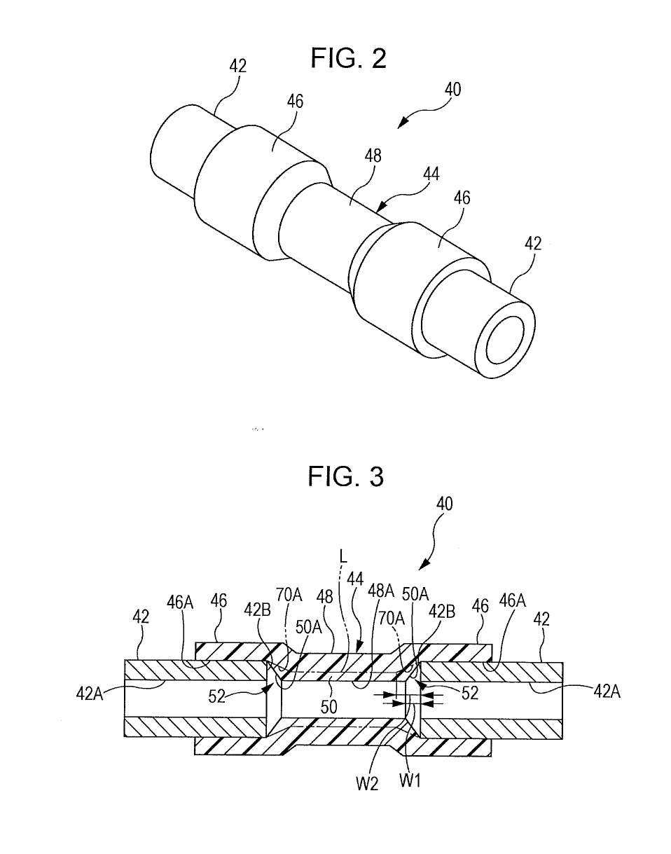

As illustrated in FIG. 2, the piping connection structure 40 has a pair of pipes 42 and a tube 44 that connects a pair of the pipes 42. The piping connection structure 40 is formed, for example, so as to be symmetric with respect to the center in its axial direction. A pair of the pipes 42 are formed as metallic cylindrical bodies.

In the piping connection structure 40 that is applied to the connection between the distribution part of the tank 32 and the inlet of each pump 34 illustrated in FIG. 1, one pipe 42 is disposed in the distribution part of the tank 32 and the other pipe 42 is disposed in the inlet of the pump 34. In the piping connection structure 40 that is applied to the connection between the outlet of each pump 34 and the junction of the tank 32, one pipe 42 is disposed in the outlet of the pump 34 and the other pipe 42 is disposed in the junction of the tank 32. In the piping connection structure 40 that is applied to the connection between the outlet of the tank 32 and the inlet of the heat receiving plate 36, one pipe 42 is disposed in the outlet of the tank 32 and the other pipe 42 is disposed in the inlet of the heat receiving plate 36.

The tube 44 illustrated in FIGS. 2 and 3 is made of rubber or plastic such as vinyl chloride, which is an example of a material softer than the metallic pipe 42. Because the entire tube 44 is made of rubber or plastic, the tube 44 has elasticity in an axial direction and a radial direction, and also has flexibility.

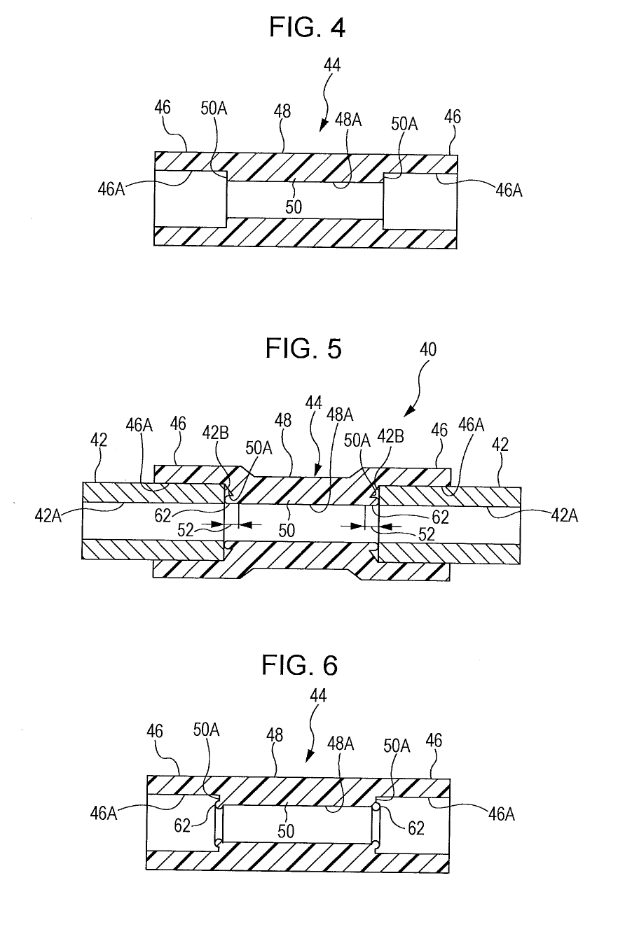

A pair of connections 46 are formed at ends of the tube 44 in the axial direction. In a status before a pair of the pipes 42 are fitted into a pair of the connections 46, the tube 44 is a round tube as illustrated in FIG. 4. In addition, in the status before a pair of the pipes 42 are fitted into a pair of the connections 46, the outer shape (outer periphery) of the tube 44 has a specific cross section (circular cross section) across the tube 44 in the axial direction.

In this embodiment, the “status before a pair of the pipes 42 are fitted into a pair of the connections 46” includes a status before the pipes 42 are fitted into the connections 46 for the first time, and a status before the pipes 42 are fitted into the connections 46 again after previous fitting of the pipes 42 into the connections 46.

A portion between a pair of the connections 46 in the tube 44 is formed as a main body 48 (intermediate portion) of the tube 44. The main body 48 is linked seamlessly with a pair of the connections 46. As illustrated in FIGS. 3 and 4, the main body 48 has a projection 50 that projects into the inside of the tube 44 in the radial direction with respect to inner peripheries 46A of a pair of the connections 46.

The projection 50 is formed across the main body 48 in the axial direction, and circularly along a circumferential direction of the main body 48. In the status before a pair of the pipes 42 are fitted into a pair of the connections 46, the projection 50 has a specific cross section across the main body 48 in the axial direction as illustrated in FIG. 4.

A pair of the pipes 42 are inserted and fitted into a pair of the connections 46 as illustrated in FIG. 3. Each pipe 42 is inserted into the connection 46 until the pipe 42 abuts against a base end of the projection 50. When the pipe 42 is fitted into the connection 46, the connection 46 is elastically deformed so that the diameter of the connection 46 is expanded.

When each pipe 42 is fitted into the connection 46, an end surface 50A (side surface) on the pipe 42 side of the projection 50 is pulled toward the end of the tube 44 in the axial direction and outward in the radial direction. The end surface 50A on the pipe 42 side of the projection 50 is inclined with respect to the radial direction of the tube 44 such that the end surface 50A is pulled outward in the radial direction of the tube 44 as the end surface 50A is pulled toward the end of the tube 44 in the axial direction.

When a pair of the pipes 42 are fitted into a pair of the connections 46 as described above, an inner periphery 48A of the main body 48 (an end surface of the projection 50) is arranged flush with inner peripheries 42A of a pair of the pipes 42. That is, the inner periphery 48A of the main body 48 and the inner peripheries 42A of a pair of the pipes 42 are placed in approximately the same position in the radial direction of the tube 44. In the piping connection structure 40, settings such as the height of the projection 50 and the elasticity of the tube 44 are made so that the inner periphery 48A of the main body 48 is arranged flush with the inner peripheries 42A of a pair of the pipes 42.

In the piping connection structure 40 that is applied to the connection between the tank 32 and each pump 34 illustrated in FIG. 1, one of the tank 32 and the pump 34 is an example of a first unit, and the other is an example of a second unit. In the piping connection structure 40 that is applied to the connection between the tank 32 and the heat receiving plate 36, one of the tank 32 and the heat receiving plate 36 is an example of the first unit, and the other is an example of the second unit. The coolant is circulated between the first unit and second unit through the above tube 44.

Next, effects of this embodiment is described.

In the piping connection structure 40 according to this embodiment, the projection 50 that projects into the inside of the tube 44 in the radial direction with respect to the inner peripheries 46A of a pair of the connections 46 is formed in the main body 48 of the tube 44 as illustrated in FIG. 3. The projection 50 is formed circularly along the circumferential direction of the main body 48, and across the main body 48 in the axial direction. Therefore, even when a pair of the pipes 42 are inserted and fitted into a pair of the connections 46, gaps 52 between the inner periphery 48A of the main body 48 and the inner peripheries 42A of a pair of the pipes 42 may be reduced with the projection 50.

If the projection 50 is omitted from the main body 48 as illustrated with a phantom line L in FIG. 3, inclined surfaces 70A are formed on the connection 46 side of the main body 48 when a pair of the pipes 42 are fitted into a pair of the connections 46. An inclination angle of the inclined surfaces 70A with respect to the radial direction of the tube 44 is larger than that of the end surfaces 50A on the pipe 42 side of the projection 50. Therefore, if the projection 50 is omitted from the main body 48, the gaps 52 between the inner periphery 48A of the main body 48 and the inner peripheries 42A of a pair of the pipes 42 are large.

In contrast, in the piping connection structure 40 according to this embodiment, the projection 50 is formed on the inner periphery side of the main body 48, and therefore the inclined surfaces on the connection 46 side of the main body 48 are the end surfaces 50A on the pipe 42 side of the projection 50. Accordingly, the inclination angle of the end surfaces 50A, which is inclined surfaces on the connection 46 side of the main body 48, may be smaller than that of the inclined surfaces 70A by a projection amount of the projection 50 formed in the main body 48. Therefore, the gaps 52 between the inner periphery 48A of the main body 48 and the inner peripheries 42A of a pair of the pipes 42 may be reduced.

If the projection 50 is omitted from the main body 48 as illustrated with the phantom line L in FIG. 3, the width of the gap 52 is W2. In this embodiment, however, the width of the gap 52 is W1, which is smaller than W2. Accordingly, a region in which the cross-sectional area of the flow path changes may be reduced in the fittings between the pipes 42 and the tube 44. This may suppress occurrence of coolant pressure loss.

In addition, the inner periphery 48A of the main body 48 is arranged flush with the inner peripheries 42A of a pair of the pipes 42. Therefore, changes are small in the cross-sectional area of the flow path formed by a pair of the pipes 42 and the tube 44. This also may suppress occurrence of coolant pressure loss.

The main body 48 has the projection 50, and is therefore thick as compared with a main body without the projection 50 (see the phantom line L in FIG. 3). Accordingly, permeation of the coolant from the main body 48 may be suppressed. It is thus possible to decrease the frequency with which a coolant is added to the cooling system 20.

Because the projection 50 is formed in the main body 48, but not in a pair of the connections 46, the thinness of a pair of the connections 46 may be maintained. Accordingly, even when a pair of the pipes 42 are fitted into a pair of the connections 46, an increase in the thickness of the piping connection structure 40 (the dimension in the radial direction) may be suppressed.

The main body 48 has the projection 50 that projects into the inside of the tube 44 in the radial direction with respect to the inner peripheries 46A of a pair of the connections 46, and the projection 50 serves as a stopper. Accordingly, the position of insertion of each pipe 42 into the connection 46 may be predetermined. Therefore, because each pipe 42 may be inserted into the connection 46 by a regular insertion amount, problems with the tube 44 such as twists, compression, and tension may be suppressed. This may prolong the life of the tube 44.

In the cooling system 20 including the piping connection structures 40 according to this embodiment as illustrated in FIG. 1, because the coolant may be circulated efficiently, the cooling performance for the heating element 16 may be improved.

In the electronic equipment 10 including the cooling system 20 according to this embodiment, an increase in the temperature of the CPU, which is an example of the heating element 16, may be suppressed, and therefore the behavior of the CPU may be stabilized.

Next, variations of the embodiment is described.

In the above embodiment, the tube 44 may also be formed as follows. In a variation illustrated in FIGS. 5 and 6, a pair of gap fillers 62 are added to the tube 44. In the status before a pair of the pipes 42 are fitted into a pair of the connections 46, each gap filler 62 projects from the corner on the connection 46 side of the end of the projection 50, and is formed circularly along the circumferential direction of the projection 50, as illustrated in FIG. 6.

When the pipes 42 are fitted into the connections 46, the gap fillers 62 are disposed in the gaps 52 between the inner periphery 48A of the main body 48 and the inner peripheries 42A of the pipes 42 as illustrated in FIG. 5. The end of each gap filler 62 comes into contact with an end surface 42B on the projection 50 side of each pipe 42.

As described above, when a pair of the gap fillers 62 are added to the tube 44, the gap fillers 62 may fill the gaps 52 between the inner periphery 48A of the main body 48 and the inner peripheries 42A of the pipes 42. This may more effectively suppress occurrence of pressure loss in the coolant circulated through the pipes 42 and the tube 44.

In particular, the ends of the gap fillers 62 come into contact with the end surfaces 42B on the projection 50 side of the pipes 42, and the gap fillers 62 seamlessly join the inner periphery 48A of the main body 48 and the inner peripheries 42A of the pipes 42. Therefore, the coolant may be circulated smoothly through the pipes 42 and the tube 44.

In the above embodiment, each pipe connection structure 40 has a pair of the connections 46. However, the piping connection structure 40 may have one connection 46.

A pair of the pipes 42 are made of metal. However, a pair of the pipes 42 may be formed of a non-metallic material such as plastic, provided that the material is harder than the tube 44.

The piping connection structure 40 is formed, for example, so as to be symmetric with respect to the center in the axial direction. However, the piping connection structure 40 may be formed so as to be asymmetric with respect to the center in the axial direction. That is, a pair of the pipes 42 may have different outer diameters. A pair of the connections 46 may have different inner diameters corresponding to the difference in the outer diameters of a pair of the pipes 42.

The piping connection structure 40 is applied to a cooling system, but may also be applied to other than the cooling system. The cooling system 20 is applied to electronic equipment, but may also be applied to other than the electronic equipment.

The electronic equipment 10 is, for example, a server. However, the electronic equipment 10 may also be other than the server, such as a desktop personal computer or mobile personal computer, for example.

Some of a plurality of the above variations may be appropriately combined when possible.

The embodiment of the techniques disclosed herein is described above. The techniques disclosed herein are not limited to the above embodiment. It will be appreciated that many other variations are possible without departing from the spirit and scope of the disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A piping connection structure comprising:
a pipe; and
an elastic tube connected to the pipe, the tube including
a connection into which the pipe is inserted and fitted, and
a main body linked seamlessly with the connection,
wherein the main body includes
a projection that is formed circularly along a circumferential direction of the main body, and across the main body in an axial direction, and
projects into an inside of the tube in a radial direction with respect to an inner periphery of the connection.

2. The piping connection structure according to claim 1,
wherein an inner periphery of the main body is arranged flush with an inner periphery of the pipe.

3. The piping connection structure according to claim 1,
wherein the tube further includes a gap filler that projects from a corner on a connection side of an end of the projection, and is formed circularly along the circumferential direction of the projection, and
wherein the gap filler is disposed in a gap between the inner periphery of the main body and the inner periphery of the pipe.

4. The piping connection structure according to claim 1,
wherein an end of the gap filler comes into contact with an end surface on a projection side of the pipe.

5. The piping connection structure according to claim 1,
wherein in a status before the pipe is fitted into the connection, the projection has a specific cross section across the main body in the axial direction.

6. The piping connection structure according to claim 1,
wherein in the status before the pipe is fitted into the connection, an outer shape of the tube has a specific cross section across the tube in the axial direction.

7. The piping connection structure according to claim 1,
wherein the tube is made of rubber or plastic.

8. The piping connection structure according to claim 1,
wherein a pair of the pipes are provided, and
wherein the connection is formed at each end of the tube in the axial direction.

9. A cooling system comprising:
a first unit and a second unit each including a pipe; and
a tube that connects a pair of the pipes and circulates a coolant between the first unit and the second unit, the tube including
a pair of connections into which a pair of the pipes are inserted and fitted, and
a main body formed between a pair of the connections,
wherein the main body includes
a projection that is formed circularly along a circumferential direction of the main body, and across the main body in an axial direction, and
projects into an inside of the tube in a radial direction with respect to inner peripheries of a pair of the connections.

10. Electronic equipment comprising:
a heating element; and
a cooling system that cools the heating element, the cooling system including
a first unit and a second unit each including a pipe, and
a tube that connects a pair of the pipes and circulates a coolant between the first unit and the second unit,
wherein the tube includes
a pair of connections into which a pair of the pipes are inserted and fitted, and
a main body formed between a pair of the connections, and
wherein the main body includes
a projection that is formed circularly along a circumferential direction of the main body, and across the main body in an axial direction, and
projects into an inside of the tube in a radial direction with respect to inner peripheries of a pair of the connections.
